(19) United States
(12) Patent Application Publication
(10) Pub. No.: US 2014/0347830 A1
(43) Pub. Date: Nov. 27, 2014

(54) ELECTRONIC DEVICE WITH RCA CONNECTOR

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventors: HE-LI WANG, Shenzhen (CN); QIN-LI HU, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 14/155,270

(22) Filed: Jan. 14, 2014

(30) Foreign Application Priority Data
May 23, 2013 (CN) 2013202839996

(51) Int. Cl. H01R 9/16

(52) U.S. Cl. CPC H01R 9/16
USPC 361/752

(57) ABSTRACT

An electronic device comprises a casing, a connector, and a fixing mechanism. The casing includes a lower cover and a back panel fixed on the lower cover. The connector is mounted on the lower cover and partly through the back panel to be exposed. The fixing mechanism that is received in the casing extends from an edge of the back panel. The fixing mechanism deforms receiving the connector and returns to its original shape for fixing the connector to the back panel.

### TECHNICAL FIELD

The present disclosure relates to electronic devices with RCA connector.

### DESCRIPTION OF RELATED ART

An electronic device, such as DVD player or television, is capable of playing audio or video. The electronic device includes a casing and a plurality of Radio Corporation of America (RCA) connectors for connection with RCA plugs are fixed on the casing with screws. However, a tool is needed for disassembling the RCA connector from the casing.

Therefore, there is room for improvement in the art.

### BRIEF DESCRIPTION OF THE FIGURE

The components of the drawings are not necessarily drawn to scale, the emphasis instead being placed upon clearly illustrating the principles of the embodiment of an electronic device. Moreover, in the drawings, like reference numerals designate corresponding parts throughout several views.

FIG. 1 is a schematic view of an electronic device, according to an embodiment.

FIG. 2 is partially disassembled view of the electronic device of FIG. 1.

FIG. 3 is an enlarged partially view of the electronic device of FIG. 2.

FIG. 4 is a partially assemble view of the electronic device of FIG. 2.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.” The references “a plurality of” and “a number of” mean “at least two.” Embodiments of the present disclosure will be described in detail with reference to the drawings.

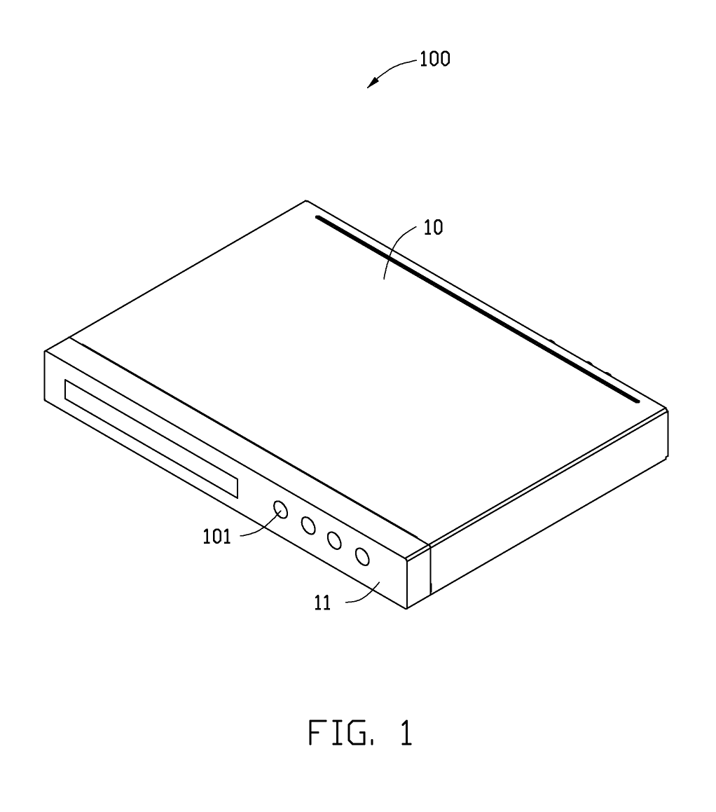

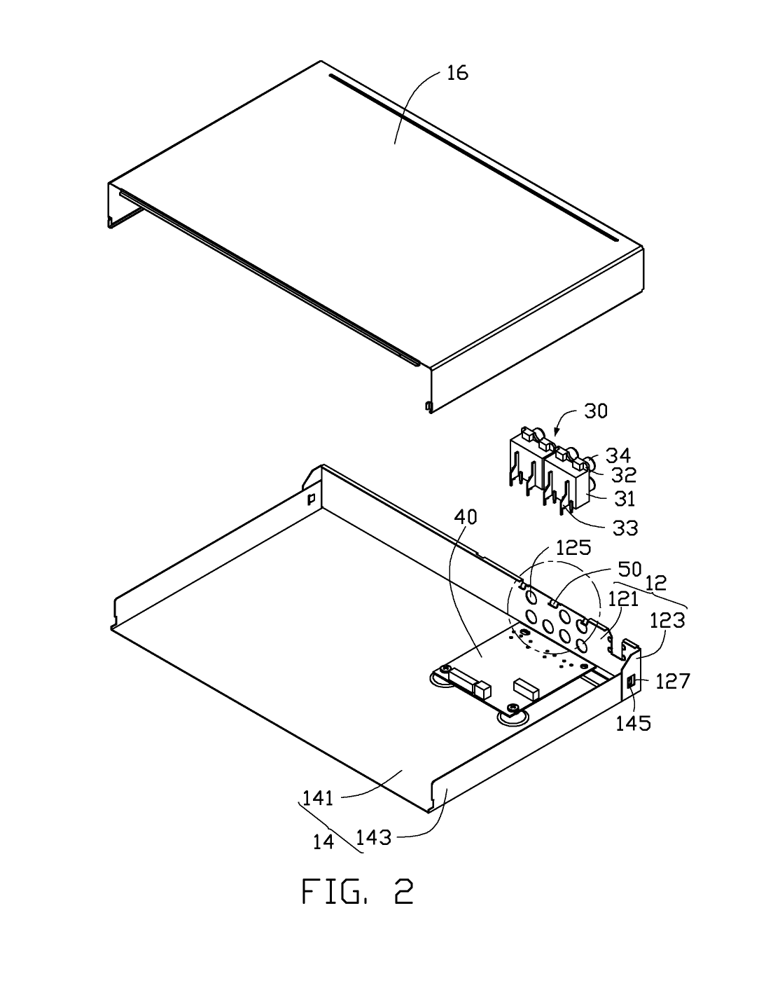

FIGS. 1 and 2 show an electronic device 100 of the embodiment. The electronic device 100 includes a casing 10, a connector 30, a printed circuit board (PCB) 40 connected with the connector 30, and a plurality of fixing mechanisms 50 parallel with each other. The connector 30, the PCB 40, and the fixing mechanism 50 are received in the casing 10, and part of the connector 30 is exposed from the casing 10. The connector 30 is fixed to the casing 10 through the fixing mechanism 50 which can be directly disassembled from the casing 10 manually without any tools. In the embodiment, the electronic device 100 can be a DVD player or a television, for example, and the connector 30 is a RCA type connector for connecting with RCA plugs.

The casing 10 includes a front panel 11, a back panel 12, a lower cover 14, and an upper cover 16. The front panel 11, the back panel 12, the lower plate 14, and the upper cover 16 cooperate with each other to form a closed space (not labeled) for receiving electronic components of the electronic device 100. The front panel 11 and the back panel 12 are perpendicularly extended from opposite edges of the lower cover 14. The front panel 11 facing the users is substantially rectangular shaped, and includes a plurality of keys 101. The back panel 12 includes a first plate 121, and two extension portions 123. The first plate 121 defines a plurality of holes 125 corresponding to the RCA plugs 30. The extension portions 123 are perpendicularly extended from opposite edges of the first plate 121 adjacent to the front panel 11, and are flexible. The extension portion 123 defines a substantially squared shaped fixing hole 127.

The lower cover 14 includes a bottom plate 141 and two sidewalls 143 perpendicular to the back panel 12. The bottom plate 141 is parallel with the upper cover 16. The sidewalls 143 are perpendicularly extended from opposite edges of the bottom plate 141. The sidewall 143 includes a locking portion 145 corresponding to the fixing hole 127. The locking portion 145 protrudes out from the sidewall 143, and cooperates with the corresponding fixing hole 127 for fixing the back panel 12 on the lower cover 14.

The connector 30 includes a main body 31, a plurality of protrusions 32, a plurality of pins 33, and a plurality of connecting portions 34 corresponding to the holes 125 in a one-to-one relationship. The main body 31 is substantially rectangular shaped. The protrusions 32 and the pins 33 are respectively set on opposite surface of the main body 31, and the connecting portions 34 are set on a surface of the main body 31 facing the back panel 12. The protrusions 32, which perpendicularly extend parallel with each other and away from the main body 31 towards to the upper cover 16. The pins 33 are inserted into the PCB 40 for establishing an electrical connection between the connector 30 and the PCB 40. The connecting portions 34 are arranged between the main body 31 and the back panel 12, and are respectively inserted into the corresponding holes 125. In the embodiment, the connector 30 is a RCA type connector for connecting with RCA plugs.

The PCB 40 is mounted on the bottom plate 141 adjacent to the back panel 12.

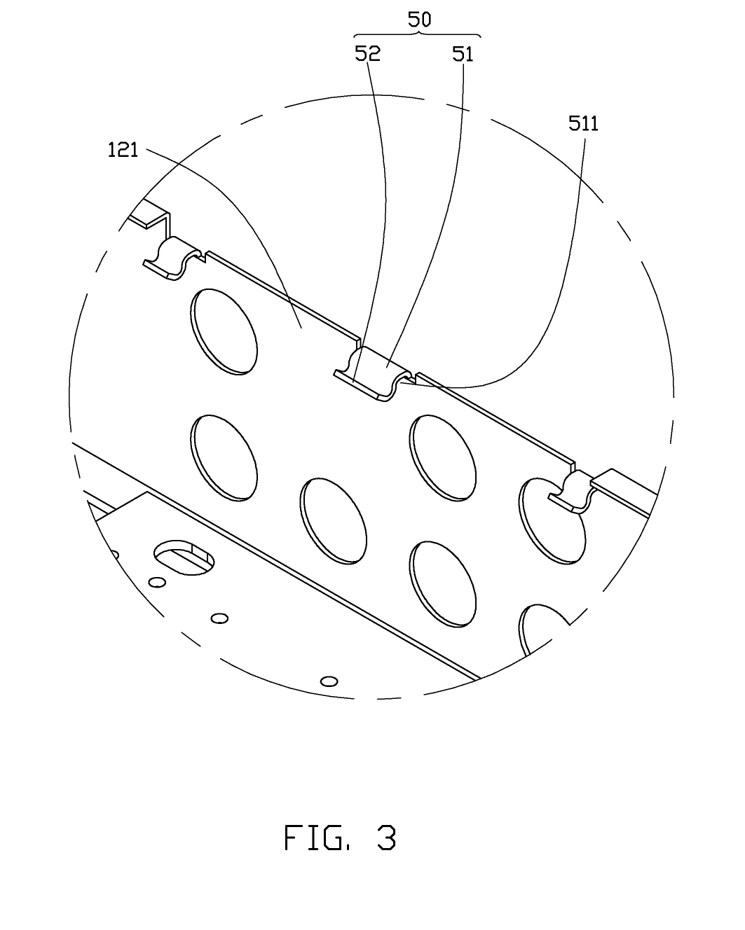

FIG. 3 shows the fixing mechanism 50 of the embodiment. The fixing mechanism 50 is substantially “S” shaped, and includes a fixing arm 51 and a resisting arm 52. The fixing arm 51 extends from an edge of the back panel 12 which is away from the lower cover 14, and bends towards to the lower cover 14. The fixing arm 51 is substantially U shaped. The fixing arm 51 defines a receiving space 511 with the opening facing the bottom plate 141. The receiving space 511 contains the protrusion portion 32. The resisting arm 52 extends from an end of the fixing arm 51, and bends away from the lower cover 14. In the embodiment, the fixing mechanism 50 is made of resilient material.

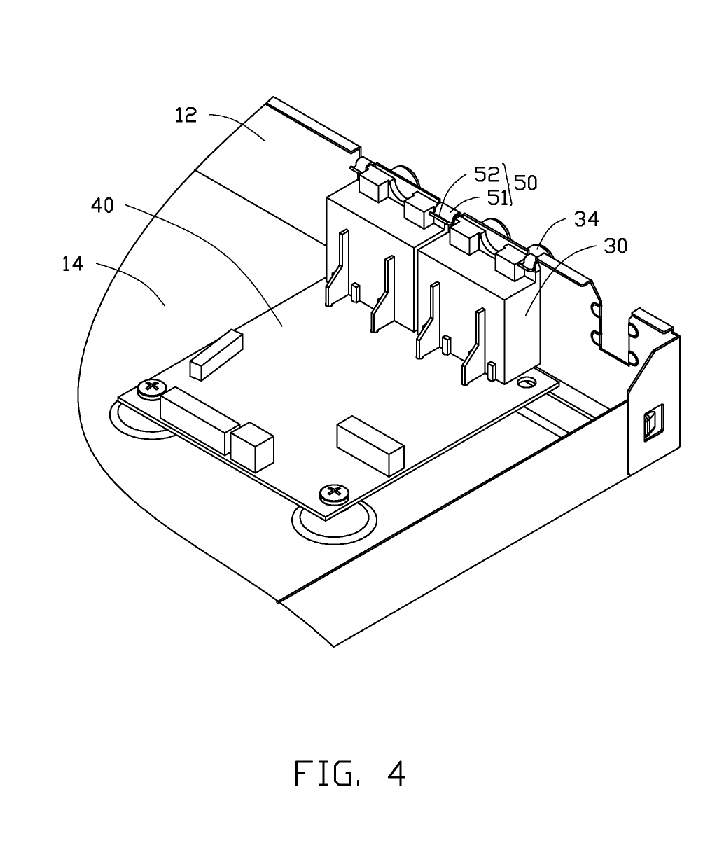

FIG. 4 shows that in assembly, the pins 33 are inserted in the PCB 40 for fixing the main body 31 to the PCB 40. The locking portion 145 is inserted into the fixing hole 127 by moving the back panel 12 towards the lower cover 14, bending the extension portion 123 which fix the back panel 12 to the lower cover 14. The connecting portion 34 passes through the corresponding holes 125 and are exposed out of the casing 10. The protrusion portion 32 deforms the resisting arm 52. When the protrusion portion 32 is received in the receiving space 511 of the fixing arm 51, the resisting arm 52 returns to its former position and resists against the protrusion portion 32. The fixing arm 51 prevents the connector 30 from moving along a direction perpendicular to the bottom plate 141, and the resisting arm 52 prevents the connector 30 from moving along a direction parallel with the bottom plate 141.

In disassembly, the back panel 12 is pulled away from the front panel 11, the fixing arm 51 and the resisting arm 52 are deformed to come apart from the protrusion portion 32.

No tools are needed for disassembling of the connector 30 from the electronic device 100. Therefore, the disassembling speed of the electronic device 100 is improved, and the process of disassembling becomes more convenient.

While various and preferred embodiments have been described, the disclosure is not limited thereto. On the contrary, various modifications and similar arrangements (as would be apparent to those skilled in the art) are intended to also be covered. Therefore, the scope of the appended claims should be accorded the broadest interpretation so as to encompass all such modifications and similar arrangements.

What is claimed is:

1. An electronic device, comprising:
a casing with a lower cover and a back panel fixed to the lower cover;
a connector mounted on the lower cover and partly through the back panel to be exposed; and
a fixing mechanism received in the casing and extended from an edge of the back panel;
wherein the fixing mechanism deforms to receives the connector and returns to its original shape for fixing the connector on the back panel.

2. The electronic device of claim 1, wherein the fixing mechanism comprises a fixing arm; the fixing arm extends from an edge of the back panel which is away from the lower cover and bends towards to the lower cover; the fixing arm defines a receiving space for receiving the connector.

3. The electronic device of claim 2, wherein the fixing arm is substantially U shaped, and the opening of the receiving space faces the lower cover.

4. The electronic device of claim 1, wherein the fixing mechanism further includes a resisting arm; the resisting arm extends from an end of the fixing arm and bends away from the lower cover.

5. The electronic device of claim 1, wherein the fixing mechanism is used for preventing the connector from moving along a direction perpendicular to the lower cover and a direction parallel with the lower cover.

6. The electronic device of claim 1, wherein the connector is a RCA type connector.

7. An electronic device, comprising:
a casing with a lower cover and a back panel fixed to the lower cover;
a connector mounted on the lower cover and partly through the back panel to be exposed; and
a fixing mechanism received in the casing and extended from an edge of the back panel;
wherein the fixing mechanism cooperates with the connector for preventing the connector from moving along a direction perpendicular to the lower cover and a direction parallel with the lower cover.

8. The electronic device of claim 7, wherein the fixing mechanism deforms to receives the connector and returns to its original shape for fixing the connector on the back panel.

9. The electronic device of claim 7, wherein the fixing mechanism includes a fixing arm; the fixing arm; the fixing arm extends from an edge of the back panel which is away from the lower cover and bends towards to the lower cover; the fixing arm defines a receiving space for receiving the connector.

10. The electronic device of claim 9, wherein the fixing arm is substantially U shaped, and the opening of the receiving space faces the lower cover.

11. The electronic device of claim 7, wherein the fixing mechanism further includes a resisting arm; the resisting arm extends from an end of the fixing arm and bends away from the lower cover.

12. The electronic device of claim 7, wherein the connector is a RCA type connector.
